(19) United States
(12) Patent Application Publication
(10) Pub. No.: US 2021/0269649 A1
(43) Pub. Date: Sep. 2, 2021

(54) LAYERED SILICATE-COATED BODY AND METHOD FOR MANUFACTURING SAME

(71) Applicants: TOPY KOGYO KABUSHIKI KAISHA, Tokyo (JP); SHINSHU UNIVERSITY, Nagano (JP)

(72) Inventors: Ryuichi SEIKE, Aichi (JP); Mai SUEYOSHI, Aichi (JP); Tomohiko OKADA, Nagano (JP); Sakura SHIMOMURA, Nagano (JP)

(21) Appl. No.: 17/184,103

(22) Filed: Feb. 24, 2021

(30) Foreign Application Priority Data
Feb. 27, 2020 (JP) 2020-31828

(51) Int. Cl. C09C 1/30; A01N 25/26

(52) U.S. Cl. CPC C09C 1/309; C09C 1/3054; C09C 1/3063; C09C 1/3081; A01N 25/26; C01P 2002/88; C01P 2004/62; C01P 2004/61; C01P 2004/03; C01P 2002/72; C01P 2002/86; C01P 2006/90

(57) ABSTRACT

Problem: To provide highly water-repellent layered silicate-coated silica particles with higher safety.

Solution: A layered silicate-coated body has a silica particle, a saponite-like layered silicate derivative coating at least part of the silica particle, and a hydrophobic functional group introduced to the silica particle and/or the layered silicate derivative.

### TECHNICAL FIELD

The present disclosure relates to a layered silicate-coated body in which at least part of a silica particle is coated with a saponite-like layered silicate derivative, and a method for manufacturing the same.

### BACKGROUND ART

Smectite-group silicates are chemically and thermally stable, and also have ion exchangeability. Therefore, smectite-group silicates are used for various applications, such as cosmetics, paint, or the like. Unfortunately, smectite-group silicates typically have fine, layered shapes, which poses a problem in handleability. Studies are therefore underway to develop techniques for coating spherical silica particles with smectite to improve handleability (e.g., Patent Literature 1 and Non-Patent Literatures 1 and 2).

Patent Literature 1 and Non-Patent Literature 1 disclose smectite-coated particles in which hectorite or saponite, both being types of smectite, is formed as a layer integrally with the silica particles on the surface thereof. Non-Patent Literature 2 discloses silica particles coated with hectorite having a methyl group or a phenyl group. In Patent Literature 1 and Non-Patent Literatures 1 and 2, reactions for synthesizing the particles are performed in an airtight container (autoclave) at high temperatures and high pressures.

### CITATION LIST

### Patent Literature

Patent Literature 1: Japanese Unexamined Patent Publication No. 2014-24711A

Non-Patent Literature 1: Tomohiko Okada, “Development of Technology for Integrating Spherical Silica Microparticles and Smectite Microcrystals,” Cosmetology, 2015, vol. 23, pp. 20-25.

Non-Patent Literature 2: Masahiro Yamauchi et al., “Crystal Growth of Layered Silicate Grafted with Organic Groups on Monodisperse Spherical Silica Particles,” Clays and Clay Minerals, 2018, vol. 66, issue 2, pp. 104-113.

### SUMMARY OF INVENTION

### Technical Problem

Hectorite includes lithium ions as interlayer ions. Thus, the hectorite-coated particles disclosed in Patent Literature 1 and Non-Patent Literatures 1 and 2 may present safety concerns, for example, when employed for cosmetic uses to be applied to the skin.

Further, the saponite-coated silica particles disclosed in Non-Patent Literature 1 are hydrophilic, and therefore pose difficulty when employed for uses requiring water repellency and uses requiring dispersion in oily solvents.

Thus, there are demands for layered silicate-coated particles that present little safety concerns and have high water repellency.

Reactions performed at high temperatures and high pressures using an autoclave, such as those disclosed in Patent Literature 1 and Non-Patent Literatures 1 and 2, are demanding in terms of facility, labor, and energy, and may also be dangerous. Also, it is difficult to add reagents in stages, or additionally add other reagents, during synthesis.

Thus, there are demands for methods with which it is possible to manufacture highly water-repellent layered silicate-coated silica particles with higher safety without pressurization or heating.

### Solution to Problem

According to a first aspect of the present disclosure, a layered silicate-coated body is provided, the layered silicate-coated body comprising a silica particle, a saponite-like layered silicate derivative coating at least part of the silica particle, and a hydrophobic functional group introduced to the silica particle and/or the layered silicate derivative.

According to a second aspect of the present disclosure, a method for manufacturing a layered silicate-coated body is provide, in which at least part of a silica particle is coated with a saponite-like layered silicate derivative, and a hydrophobic functional group is introduced to the silica particle and/or the saponite-like layered silicate derivative. The method comprises a mixing step of mixing, in a solvent, the silica particle, alkoxysilane, a silicate component constituting the saponite-like layered silicate derivative, and a base at atmospheric pressure and at a room temperature.

### Advantageous Effects of Invention

According to the present disclosure, it is possible to provide a highly water-repellent layered silicate-coated body with higher safety.

According to the present disclosure, it is possible to provide a method for manufacturing a layered silicate-coated body under simpler conditions.

### BRIEF DESCRIPTION OF DRAWINGS

FIG. 1 is a schematic diagram for illustrating a method for manufacturing a layered silicate-coated body.

FIG. 2 is a schematic diagram for illustrating a method for manufacturing a layered silicate-coated body.

FIG. 3 is a flowchart of a layered silicate-coated body manufacturing method according to a second embodiment.

FIG. 4 is a flowchart illustrating an aspect of the second embodiment.

FIG. 5 is an SEM image of a product according to Test Example 1.

FIG. 6 is an SEM image of a product according to Test Example 2.

FIG. 7 is an SEM image of a product according to Test Example 3.

FIG. 8 is an SEM image of a product according to Test Example 3.

FIG. 9 is an SEM image of a product according to Test Example 3.

FIG. 10 is a TEM image of a product according to Test Example 3.

FIG. 11 is an SEM image of silica particles used in Test Examples 1 to 3.

FIG. 12 is an X-ray diffraction pattern of respective products according to Test Examples 1 to 3.

FIG. 13 is a solid-state ²³Na MAS NMR chart.

FIG. 14 is a solid-state ²⁷Al MAS NMR chart.

FIG. 15 is a solid-state ¹³C MAS NMR chart.

FIG. 16 is a TG-DTA chart for the product according to Test Example 1.

FIG. 17 is a TG-DTA chart for the product according to Test Example 2.

FIG. 18 is a TG-DTA chart for the product according to Test Example 3.

FIG. 19 is a photograph of the product according to Test Example 3.

FIG. 20 is a photograph of the product according to Test Example 4.

FIG. 21 is a solid-state ²³Na MAS NMR chart for a product according to Test Example 4.

FIG. 22 is a photograph illustrating dispersed states of the layered silicate-coated body according to Test Example 5.

### DESCRIPTION OF EMBODIMENTS

Preferred modes of the various aspects of the present disclosure will be described below.

According to a preferred mode of the first aspect, the hydrophobic functional group is at least one selected from the group consisting of alkyl groups and aryl groups.

According to a preferred mode of the first aspect, the hydrophobic functional group is an alkyl group having 6 or more carbon atoms.

According to a preferred mode of the first aspect, the layered silicate-coated body comprises from 0.01 to 10 mmol of the hydrophobic functional group with respect to 1 g of the layered silicate-coated body.

According to a preferred mode of the first aspect, the layered silicate derivative occupies from 0.1 to 35% by mass of the mass of the layered silicate-coated body.

According to a preferred mode of the first aspect, an average particle size of the silica particle is from 0.1 to 100 μm.

According to a preferred mode of the first aspect, the layered silicate-coated body further comprises a carried component carried by the layered silicate derivative.

According to a preferred mode of the first aspect, the carried component is at least one selected from the group consisting of ionic functional substances and ionic organic colorants.

According to a preferred mode of the first aspect, the functional substance contains at least one selected from the group consisting of antibacterial substances, bactericidal substances, sterilizing substances, and disinfecting substances.

According to a preferred mode of the first aspect, the functional substance is at least one selected from the group consisting of metal ions, ionic metal complexes, and cationic surfactants.

According to a preferred mode of the first aspect, the functional substance contains at least one selected from the group consisting of a silver ion, a zinc ion, a copper ion, a diammine silver ion, a benzalkonium ion, a benzethonium ion, a tetraethylammonium ion, and a didecyldimethylammonium ion.

According to a preferred mode of the first aspect, the ionic organic colorant contains at least one selected from the group consisting of amaranth, new coccine, phloxine B, rose bengal, acid red, tartrazine, sunset yellow, fast green, brilliant blue, indigo carmine, lithol rubine B, lithol rubine BCA, methylene blue, rhodamine B, and erythrosine B.

According to a preferred mode of the first aspect, the layered silicate-coated body further comprises a multivalent cation. The carried component is anionic and/or amphoteric.

According to a preferred mode of the first aspect, the multivalent cation is at least one selected from the group consisting of a magnesium ion, a calcium ion, an aluminum ion, and a barium ion.

According to a preferred mode of the second aspect, the mixing step comprises a first step of mixing the silica particle, the alkoxysilane, and the base, and a second step of adding the silicate component to a mixture obtained in the first step.

According to a preferred mode of the second aspect, in the first step, the base is added in stages.

According to a preferred mode of the second aspect, in the second step, the alkoxysilane and the base are further added.

In the following description, reference signs in the drawings are provided for the understanding of the invention and are not intended to limit the invention to the aspects shown. The drawings are for facilitating the understanding of silicate-coated bodies according to the present disclosure, and are not intended to limit the silicate-coated bodies to aspects illustrated in the drawings, such as illustrated shapes, dimensions, and scales. In each embodiment, the same components are accompanied by the same reference signs.

A layered silicate-coated body according to a first embodiment of the present disclosure will be described.

The silicate-coated body of the present disclosure contains silica particles (silicon dioxide; SiO₂), a saponite-like layered silicate derivative, and a hydrophobic functional group.

The silica particles may have any shape. For example, the silica particles may have a spherical shape, a platy shape, a scaly shape, or an indefinite shape. Preferably, the silica particles are spherical. The shape of the silica particles can be observed, for example, with a microscope. The silica particles may be porous or non-porous. The silica's surface (except for the hydrophobic functional group) is preferably hydrophilic.

The average particle size of the silica particles (silica powder) may be, for example, 0.1 μm or greater, 0.2 μm or greater, 0.5 μm or greater, 1 μm or greater, 2 μm or greater, 5 μm or greater, 10 μm or greater, or 20 μm or greater. The average particle size of the silica particles (silica powder) may be, for example, 100 μm or less, 80 μm or less, 70 μm or less, 50 μm or less, 20 μm or less, or 10 μm or less. The average particle size of the silica particles can be measured, for example, by laser diffraction particle size distribution measurement.

The fundamental structure of the saponite-like layered silicate derivative is saponite. An ideal composition of saponite can be expressed as Naₓ(Mg₆(Si₈₋ₓAlₓ)O₂₀(OH)₄. Saponite includes tetrahedral sheets constituted by Si (silicon), Al (aluminum) and O (oxygen), octahedral sheets constituted by Mg (magnesium) and O, and interlayer ions constituted by Na⁺ (sodium). The saponite-like layered silicate derivative of the present disclosure may include structures in which a portion of the octahedral sheet is substituted by Al. Further, as described below, the saponite-like layered silicate derivative of the present disclosure may have silica and a hydrophobic functional group bonded thereto.

The layered silicate derivative coats at least part of the outer surface of the silica particle. It is thought that the layered silicate derivative is present on the outer surface of the silica particle by a covalent bond between a silicate layer of the layered silicate derivative and a silanol group on the silica particle surface.

The presence of the saponite-like layered silicate derivative can be confirmed by X-ray diffraction analysis and solid-state ²⁷Al MAS (magic angle spinning) NMR (nuclear magnetic resonance) of the layered silicate-coated body.

The thickness of the saponite-like layered silicate derivative on the outer surface of the silica particles may be 5 nm or greater, preferably 10 nm or greater. The thickness of the saponite-like layered silicate derivative on the outer surface of the silica particles may be 100 nm or less, preferably 50 nm or less. The thickness of the layered silicate derivative can be determined with a transmission electron microscope (TEM).

The content of the layered silicate derivative with respect to the mass of the layered silicate-coated body is preferably 0.1% by mass or greater, more preferably 0.5% by mass or greater, even more preferably 1% by mass or greater. The content of the layered silicate derivative with respect to the mass of the layered silicate-coated body may be, for example, 2% by mass or greater, 5% by mass or greater, or 10% by mass or greater. If the content of the layered silicate derivative is less than 0.1% by mass, sufficient water repellency cannot be obtained. The content of the layered silicate derivative with respect to the mass of the layered silicate-coated body may be, for example, 30% by mass or less, 25% by mass or less, 20% by mass or less, 15% by mass or less, 10% by mass or less, 8% by mass or less, 5% by mass or less, or 2% by mass or less. If the content of the layered silicate derivative exceeds 35% by mass, portions of the layered silicate derivative may become difficult to integrate with the spherical silica surface.

The content by percentage of the layered silicate derivative in the layered silicate-coated body can be calculated, for example, from the Langmuir adsorption isotherm. The Langmuir adsorption isotherm can be expressed as Math. 1. In Math. 1, q is the amount of adsorbed colorant, qₘ is the maximum colorant adsorption amount (saturated adsorption amount), K is the equilibrium constant, and C is the concentration of added colorant (equilibrium concentration). First, a certain amount (e.g., x grams) of the layered silicate derivative and a colorant (e.g., methylene blue) are mixed in water, and the colorant adsorption amount q based on the layered silicate derivative in the supernatant liquid is calculated. This is repeated while varying the colorant addition amounts C, to find the respective colorant adsorption amounts q relative to the colorant addition amounts C. Math. 1 can be changed to Math. 2. The measured values are plotted according to Math. 2, wherein the horizontal axis indicates the colorant addition amount C and the vertical axis indicates the ratio, C/q, of the colorant addition amount C to the adsorption amount q, to find the first maximum colorant adsorption amount qₘ and the first equilibrium coefficient K for the layered silicate derivative from the slope (1/qₘ) and the intercept (1/qₘK). Next, in the same way, the colorant addition amounts C and the colorant adsorption amounts q are measured for a certain amount (e.g., x grams) of the layered silicate-coated body of the present disclosure (i.e., for the layered silicate derivative contained in the layered silicate-coated body), instead of the layered silicate derivative, to find the second maximum colorant adsorption amount qₘ and the second equilibrium coefficient K. The content by percentage of the layered silicate derivative in the layered silicate-coated body can be calculated by comparing the first maximum colorant adsorption amount qₘ and the second maximum colorant adsorption amount qₘ.

$$\begin{matrix}q = \frac{{q}_{m} \cdot K \cdot C}{1 + K \cdot C} & [ Math . 1 ] \\ \frac{C}{q} = \frac{1}{{q}_{m}} \cdot C + \frac{1}{{q}_{m} \cdot K} & [ Math . 2 ]\end{matrix}$$

The hydrophobic functional group is introduced to at least a portion of the silica particle's outer surface and/or the layered silicate derivative. It is thought that the hydrophobic functional group is introduced to both the silica particles and the layered silicate derivative. It is thought that the hydrophobic functional group forms a covalent bond with at least a portion of the silica particle's outer surface and/or the layered silicate derivative. In the silica particle, it is thought that the hydrophobic functional group bonds with a silicon atom on the outer surface of the silica particle. In the layered silicate derivative, it is thought that the hydrophobic functional group bonds with a silicon atom in the layered silicate derivative.

The hydrophobic functional group is not particularly limited, so long as the introduction of the hydrophobic functional group can make the water repellency of the layered silicate-coated body higher than layered silicate-coated bodies not having a hydrophobic functional group. The hydrophobic functional group may be an organic functional group. Examples of the hydrophobic functional group may include hydrocarbon groups. The configuration of the hydrocarbon group may be a straight chain, a branched chain, or cyclic. For example, the hydrocarbon group may be at least one selected from the group consisting of alkyl groups, aryl groups, and cycloalkane groups. The number of carbon atoms in the alkyl group may be, for example, 1 or greater, 3 or greater, 6 or greater, 8 or greater, or 10 or greater. The number of carbon atoms in the alkyl group may be, for example, 20 or less, 18 or less, 14 or less, 12 or less, 10 or less, or 8 or less. An example of the aryl group may be a phenyl group. The phenyl group may have a substituent, or may be unsubstituted. The hydrophobic functional group may contain a hetero atom. In cases where it is desired to improve the water repellency of the layered silicate-coated body, the hydrophobic functional group may be, for example, a straight-chain alkyl group having 6 or more carbon atoms.

The amount of introduction of the hydrophobic functional group can be set as appropriate depending on, for example, the number of carbon atoms in the hydrophobic functional group, the three-dimensional structure thereof, or the like. It is preferred that the amount of the hydrophobic functional group with respect to 1 g of the layered silicate-coated body is preferably 0.002 mmol (millimole) or greater, more preferably 0.005 mmol or greater. The amount of the hydrophobic functional group with respect to 1 g of the layered silicate-coated body may be, for example, 0.01 mmol or greater, 0.03 mmol or greater, 0.05 mmol or greater, 0.1 mmol or greater, 0.2 mmol or greater, 0.5 mmol or greater, 1 mmol or greater, or 2 mmol or greater. If the amount of the hydrophobic functional group is less than 0.002 mmol/g, the layered silicate-coated body will not be able to exert sufficient water repellency. The amount of the hydrophobic functional group with respect to 1 g of the layered silicate-coated body may be, for example, 10 mmol or less, 8 mmol or less, 5 mmol or less, 3 mmol or less, or 1 mmol or less.

The amount of the hydrophobic functional group in the layered silicate-coated body can be determined by thermogravimeter-differential thermal analysis (TG-DTA). For example, when the layered silicate-coated body is heated from 120° C. to 800° C., the mass of the layered silicate-coated body decreases. This reduction in mass is caused by the combustion of organic groups in the hydrophobic functional group, condensation reactions of hydroxy groups contained in the material silica powder, and the combustion of organic substances. It is thus conceivable that the difference found by subtracting the amount of reduction attributable to silica from the total amount of mass reduction is caused by decomposition etc. of the hydrophobic functional group. So, based on the molecular weight of the hydrophobic functional group, it is possible to calculate the amount of the hydrophobic functional group in the layered silicate-coated body from the difference in the mass reduction amount. The mass reduction amount attributable to silica can be derived by TG-DTA for the material silica powder alone.

The layered silicate-coated body of the present disclosure enables properties of saponite to be employed with the same handleability as silica powder. Since saponite contains no lithium ions, safety to the skin can be improved compared to hectorite.

Thanks to the hydrophobic functional group, the layered silicate-coated body of the present disclosure has higher water repellency than layered silicate alone. The layered silicate-coated body of the present disclosure can be dispersed in alcohols, oily solvents (e.g., hexane), or the like.

The layered silicate-coated body of the present disclosure can impart novel actions and/or properties to silica powder through the layered silicate. For example, as will be explained in the below-described third embodiment, novel functions (e.g., antibacterial actions) can be imparted to the layered silicate-coated body, and/or the layered silicate can be colored.

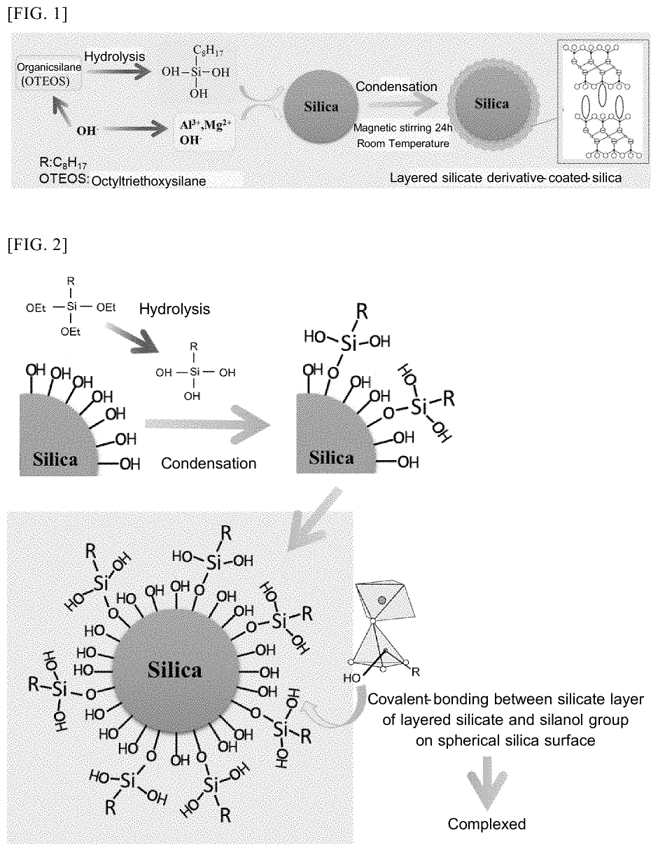

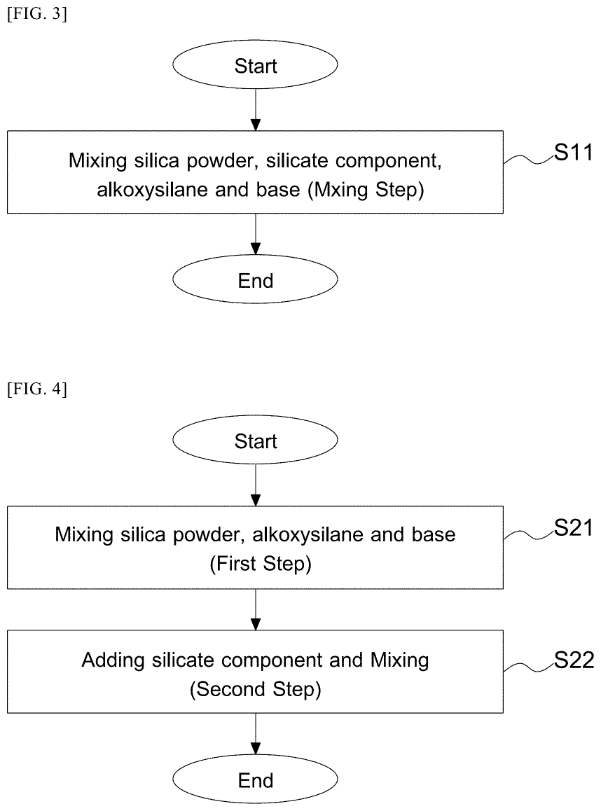

As a second embodiment of the present disclosure, a method for manufacturing the layered silicate-coated body according to the first embodiment will be described. FIGS. 1 and 2 show schematic diagrams for illustrating a method for manufacturing a layered silicate-coated body. The method described below is one aspect, and the method for manufacturing the layered silicate-coated body of the present disclosure is not limited to the following manufacturing method. The reaction mechanism included in the following description and drawings is supplementary, and it is not intended to limit the manufacturing method of the present disclosure. That is, even if an actual reaction mechanism proves to be different from the below-mentioned mechanism, that will not influence the following manufacturing method. FIG. 3 illustrates a flowchart of a layered silicate-coated body manufacturing method according to the second embodiment.

First, silica powder, alkoxysilane, compounds (silicate components) serving as materials for the saponite-like layered silicate derivative, and a base are prepared.

The silica powder is an aggregate of the aforementioned silica particles, and thus, explanation thereon will be omitted.

Alkoxysilane is a silicon compound in which at least one of the aforementioned hydrophobic functional group and at least one alkoxy group are bonded. Examples of alkoxy groups that may be used include a methoxy group, an ethoxy group, or the like. Examples of alkoxysilane that may be used include triethoxy-n-octylsilane (CH₃(CH₂)₇Si(OCH₂CH₃)₃), methyltriethoxysilane (CH₃Si(OCH₂CH₃)₃), phenyltriethoxysilane (C₆H₅Si(OCH₂CH₃)₃), or the like. FIGS. 1 and 2 illustrate an example wherein triethoxy-n-octylsilane is used as the alkoxysilane.

The compounds serving as materials for the saponite-like layered silicate derivative are a silicon compound, a magnesium compound, an aluminum compound, and a sodium compound. Examples of the silicon compound may include silane compounds. Stated differently, the aforementioned alkoxysilane can be employed as a silicon source. An example of the magnesium compound may include magnesium nitrate hexahydrate (Mg(NO₃)₂.6H₂O). An example of the aluminum compound may include aluminum acetylacetonate ([CH₃COCHCOCH₃]₃Al). The sodium compound is electrolytically dissociated in water to produce sodium ions. Examples of the sodium compound may include sodium hydroxide (NaOH) and sodium chloride (NaCl). Among these, sodium hydroxide can serve also as a base.

The base is a compound for hydrolyzing the alkoxysilane. An example of the base that may be used includes sodium hydroxide (NaOH). As described above, using sodium hydroxide as the base can also serve as a sodium ion source.

Next, the silica powder, the magnesium compound, the aluminum compound, the sodium compound, the alkoxysilane, and the base are mixed in a solvent (S11; mixing step). For the solvent, for example, water can be used. It is preferred to perform mixing for at least several hours, and for example, it is preferred to perform mixing continuously for at least 24 hours. Mixing can be performed, for example, by the spinning of a stir bar using a magnetic stirrer.

The alkoxysilane is hydrolyzed by the base. This hydrolysis produces a compound having a hydrophobic functional group and a silanol group. It is thought that this compound undergoes a condensation reaction with the silanol group on the silica particle surface, and thereby the hydrophobic functional group is introduced on the silica particle surface. It is surmised that a saponite-like layered silicate derivative is formed on the silica particle surface based on the silanol group bonding to the silica particle surface. It is thought that, in the course of formation of the saponite-like layered silicate derivative, the hydrophobic functional group is introduced also to the layered silicate derivative.

The amount of addition of the alkoxysilane, the base and the silicate component can be adjusted as appropriate depending on the amount of synthesis of the layered silicate derivative in the layered silicate-coated body. For example, in cases where the content of the layered silicate derivative is to be 0.1% by mass or greater with respect to the mass of the layered silicate-coated body, the amount of the magnesium compound may be 0.05 parts by mass or greater, the amount of the aluminum compound may be 0.06 parts by mass or greater, the amount of the sodium compound may be 0.017 parts by mass or greater, the amount of the alkoxysilane may be 0.1 parts by mass or greater, and the amount of the base may be 0.01 parts by mass or greater, with respect to 10 parts by mass of the silica powder. In cases where the content of the layered silicate derivative is to be 1% by mass or greater with respect to the mass of the layered silicate-coated body, the amount of the magnesium compound may be 0.5 parts by mass or greater, the amount of the aluminum compound may be 0.6 parts by mass or greater, the amount of the sodium compound may be 0.17 parts by mass or greater, the amount of the alkoxysilane may be 1 part by mass or greater, and the amount of the base may be 0.1 parts by mass or greater, with respect to 10 parts by mass of the silica powder. In cases where the content of the layered silicate derivative is to be 35% by mass or less with respect to the mass of the layered silicate-coated body, the amount of the magnesium compound may be 18 parts by mass or less, the amount of the aluminum compound may be 23 parts by mass or less, the amount of the sodium compound may be 7.5 parts by mass or less, the amount of the alkoxysilane may be 39 parts by mass or less, and the amount of the base may be 5 parts by mass or less, with respect to 10 parts by mass of the silica powder. In cases where the content of the layered silicate derivative is to be 10% by mass or less with respect to the mass of the layered silicate-coated body, the amount of the magnesium compound may be 5 parts by mass or less, the amount of the aluminum compound may be 6 parts by mass or less, the amount of the sodium compound may be 2.1 parts by mass or less, the amount of the alkoxysilane may be 11 parts by mass or less, and the amount of the base may be 1.49 parts by mass or less, with respect to 10 parts by mass of the silica powder. In cases where sodium hydroxide is used as the base, sodium hydroxide may be included in the sodium compound.

Mixing does not require pressurization/heating in an autoclave. Mixing can be performed at atmospheric pressure and room temperature. Room temperature may be, for example, 5° C. or higher, 10° C. or higher, 20° C. or higher, or 30° C. or higher. Room temperature may be, for example, 40° C. or lower, 35° C. or lower, 30° C. or lower, or 25° C. or lower.

A product can be obtained by isolating the product by centrifugal separation/dehydration etc. and drying the product.

The alkoxysilane and the base can be added simultaneously with the silicate component, or may be added before the silicate component. The whole amount of the alkoxysilane and the base may be added at the start of mixing, or may be added in stages (successively) during the mixing step. For example, a mixture of the alkoxysilane and the base may be added in two to four parts. Alternatively, the whole amount of the alkoxysilane may be added first, and then the base may be added in stages. By adding the alkoxysilane and the base successively, it becomes easier to integrate the layered silicate derivative and the silica particles.

FIG. 4 is a flowchart illustrating an aspect of the layered silicate-coated body manufacturing method. For example, the mixing step may include a first step for reacting the silica and the alkoxysilane (S21), and a second step for forming, after the first step, a layered silicate derivative on the surface of the silica particles (S22). The first step may involve a step of mixing the silica particles, the alkoxysilane, and the base in a solvent. In the first step, the base may be added in a plurality of parts (successively). By adding the base in stages, the reaction efficiency between the silica and the alkoxysilane can be improved. Further, condensation reactions between the alkoxysilane can be suppressed. Furthermore, the layered silicate derivative can coat the silica particles more uniformly. The second step may involve a step of adding the magnesium compound and the aluminum compound to the mixture obtained in the first step, and further mixing the same. The second step may further involve a step of further adding the alkoxysilane and the base. By forming the layered silicate derivative after reacting the silica and the alkoxysilane, the silica and the layered silicate derivative can be integrated (bonded) more easily.

With the layered silicate-coated body manufacturing method according to the second embodiment of the present disclosure, the layered silicate-coated body according to the first embodiment can be manufactured. According to the manufacturing method of the present disclosure, silica particles can be coated with a saponite-like layered silicate, even in cases where there is no adhesiveness or joining ability between the saponite-like layered silicate and the silica particles. Further, even in cases where the silica is in the form of powder, the saponite-like layered silicate can be coated at the particle level. The manufacturing method of the present disclosure can increase the degree of freedom in designing the saponite-like layered silicate, and can also expand the use thereof.

The layered silicate-coated body manufacturing method according to the second embodiment of the present disclosure does not require heating nor pressurization. Thus, the layered silicate-coated body can be manufactured more safely under simpler conditions. Further, with the layered silicate-coated body manufacturing method according to the second embodiment of the present disclosure, the layered silicate-coated body can be manufactured with smaller energy with simpler equipment.

The layered silicate-coated body manufacturing method according to the second embodiment of the present disclosure does not employ an airtight container. Thus, it is easy, for example, to add materials successively, or add reagents during reaction.

A layered silicate-coated body according to a third embodiment of the present disclosure will be described.

The layered silicate-coated body according to the third embodiment contains the layered silicate-coated body according to the first embodiment, and further contains a carried component carried by the saponite-like layered silicate derivative. Examples of the carried component may include functional substances and/or ionic colorants. In the present disclosure, the terms “functional substance” and “ionic colorant” may refer either to the form of a compound, to the form of a salt before ionization, or to the form of an ion after electrolytic dissociation.

Preferably, the carried component is a substance that dissolves in water in the form of ions (i.e., an ionic substance). The carried component may be an inorganic compound or an organic compound. The carried component may be any one of a cationic substance, an anionic substance, an amphoteric substance, an acidic substance, or a basic substance. It is thought that the carried component forms a complex with the layered silicate derivative. It is thought that the carried component is adsorbed by the layered silicate derivative by ionic interaction and/or electrostatic interaction. For example, the carried component can be carried by the layered silicate derivative through ion exchange with interlayer ions of the layered silicate derivative.

In cases where the carried component is a cationic substance, it is thought that the carried component is incorporated into the layered silicate derivative by ionic exchange with an exchangeable positive ion (sodium ion) in the saponite-like layered silicate derivative. It is also thought that the carried component is adsorbed by the layered silicate derivative by the ionic/electrostatic interaction between an ionic moiety of the carried component and a sheet structure of the layered silicate derivative.

In cases where the carried component is an anionic substance and/or an amphoteric substance, the layered silicate-coated body further contains a multivalent ion. The multivalent ion may be a di- or higher valent cation. Examples of the multivalent ion may include, although not limited to, alkaline-earth metal ions and metal ions. Examples of the multivalent cation may include, although not limited to, a magnesium ion (Mg²⁺), calcium ion (Ca²⁺), aluminum ion (Al³⁺), and barium ion (Ba²⁺). Other examples of multivalent cations may include complex ions such as a hexaaquaaluminum ion ([Al(H₂O)₆]³⁺).

In cases where the carried component is an anionic substance and/or an amphoteric substance, it is thought that the carried component is incorporated into the layered silicate derivative via a multivalent cation. Since the carried component has the same charge as the sheet structure of the layered silicate derivative, the carried component cannot be incorporated into the layered silicate derivative by direct ionic exchange with an exchangeable positive ion in the layered silicate derivative. It is therefore thought that, by interposing the multivalent cation having a charge opposite to that of the sheet structure between the carried component and the sheet structure of the layered silicate derivative, the carried component is adsorbed by the layered silicate derivative by the ionic/electrostatic interaction among the ionic functional group of the carried component, the multivalent cation, and the sheet structure of the layered silicate derivative.

Whether the carried component is cationic or anionic can be determined by the counter ion. In cases where the counter ion is an anion, the carried component is cationic, which has the opposite charge. In cases where the counter ion is a cation, the carried component is anionic, which has the opposite charge. An amphoteric component may carry both a positive charge and a negative charge within a molecule, thereby making the net charge of the whole molecule zero.

Since the charge of the multivalent cation needs to be theoretically equivalent to the charge of the sheet structure of the layered silicate derivative and the charge of the ionic functional group of the carried component opposing the sheet structure (or the charge of the whole carried component), the charge of the multivalent cation needs to have a valence of two or more (e.g., divalent, trivalent, or the like).

Examples of functional substances usable herein may include, although not limited to, substances having, e.g., antibacterial, bactericidal, sterilizing, disinfectant, or other actions (e.g., antibacterial agents, bactericides, sterilizing agents, or disinfectants). Examples of such functional substances may include, although not limited to: metal ions such as silver, zinc and copper ions; ionic metal complexes containing a metal ion such as a silver, zinc, or copper ion (e.g., a diamminesilver ion); and cationic surfactants such as quaternary ammonium salts (e.g., a benzalkonium ion, a benzethonium ion, a tetraethylammonium ion, and a didecyldimethylammonium ion).

Examples of ionic organic colorants usable herein may include, although not limited to, tar colorants (statutory colorants) stipulated, for example, in “Ministerial Ordinance to Establish Tar Colors Usable in Pharmaceuticals.” Examples of ionic organic colorants may include, although not limited to, one or more of colorants belonging to Group I, such as amaranth (red No. 2), erythrosine (red No. 3; tetraiodofluorescein sodium salt), new coccine (red No. 102), phloxine B (red No. 104), rose bengal (red No. 105), acid red (red No. 106), tartrazine (yellow No. 4), sunset yellow (yellow No. 5), fast green (green No. 3), brilliant blue (blue No. 1; erioglaucine A; acid blue 9), and indigo carmine (blue No. 2), and colorants belonging to Group II, such as lithol rubine B (red No. 201), lithol rubine BCA (red No. 202), and rhodamine B (red No. 213; basic violet 10).

Examples of cationic organic colorants usable herein may include, although not limited to, methylene blue and rhodamine B. Examples of anionic organic colorants usable herein may include, although not limited to, erythrosine B, tartrazine, sunset yellow FCF, brilliant blue FCF, amaranth, new coccine, phloxine B, rose bengal, indigo carmine, sunset yellow, and lithol rubine B. Examples of amphoteric organic colorants usable herein may include, although not limited to, acid red and fast green FCF.

The content by percentage of the carried component can be set as appropriate depending on the intended purpose, properties, or the like.

The content by percentage of the carried component with respect to the mass of the layered silicate-coated body may be, for example, preferably 0.05% by mass or greater, more preferably 0.1% by mass or greater. If the content of the carried component is less than 0.05% by mass, sufficient actions cannot be obtained. The content by percentage of the carried component with respect to the mass of the layered silicate-coated body may be, for example, 15% by mass or less, 10% by mass or less, 5% by mass or less, or 1% by mass or less.

The content by percentage of the multivalent cation can be suitably set according to the content by percentage of the anionic substance. The content by percentage of the multivalent cation relative to the mass of the layered silicate-coated body may be, for example, 0.1% by mass or greater. The content by percentage of the multivalent cation relative to the mass of the layered silicate-coated body may be, for example, 10% by mass or less.

The amount of functional substance adsorbed by the layered silicate-coated body can be measured, for example, by inductively coupled plasma-mass spectrometry (ICP-MS).

The amount of the ionic organic colorant adsorbed by the layered silicate-coated body can be measured by absorption wavelength analysis by spectroscopic analysis, for example. The adsorbed amount of the colorant can be determined by comparing the peak intensity of the colored silicate-coated body with the peak intensity of a colorant solution having a prescribed concentration.

The layered silicate-coated body according to the third embodiment can obtain the same effects as the layered silicate-coated body according to the first embodiment. To impart water repellency to smectite-coated silica particles having no hydrophobic functional group, it is necessary to intercalate a water-repellent component (e.g., an alkylammonium ion) between the layers of smectite by cation exchange. In such cases, it is not possible to allow adsorption of functional components or coloring components other than the water-repellent component. In contrast, according to the layered silicate-coated body of the present disclosure, the hydrophobic functional group exerts water repellency, and therefore, components other than the water-repellent component can be adsorbed to the layered silicate derivative. Thus, it is possible to achieve both water repellency and actions based on the other components.

In the layered silicate-coated body of the present disclosure, the layered silicate derivative is able to carry functional substances through ion exchange. Thus, particularly, the layered silicate-coated body can exhibit functions/actions ascribable to the carried functional substance. For example, in cases where an antibacterial substance is carried, the silicate-coated body can exhibit antibacterial actions.

The colored and layered silicate-coated body, which carries the ionic organic colorant, of the present disclosure can be used, for example, as a pigment. The ionic organic colorant adsorbed by the layered silicate is hard to desorb, thus making decoloration and color migration less likely. By using a highly safe ionic organic colorant, a highly safe colored and layered silicate-coated body can be obtained. The colored and layered silicate-coated body is less prone to aggregate, and thus can be easily used. For example, the colored layered silicate-coated body is therefore applicable to cosmetics and the like.

The colored layered silicate-coated body of the present disclosure has high usability as a pigment. Typical dyes/pigments used for cosmetics or the like aggregate because they generally undergo a drying step. Therefore, typical dyes/pigments can only be used after the aggregates have been crushed by one of various methods at the time of use. In contrast, the colored silicate-coated body of the present disclosure is less prone to aggregate. Therefore, the colored silicate-coated body of the present disclosure does not require dispersing/crushing, and is therefore highly usable. With typical dyes/pigments, aggregation gives rise to a change in color strength as well as degradation in texture. In contrast, according to the colored layered silicate-coated body of the present disclosure, changes in color strength and degradation in texture can be suppressed.

According to the colored layered silicate-coated body of the present disclosure, the stability of the ionic organic colorant can be enhanced, and thereby fading can be suppressed. Some unadsorbed ionic organic colorants are easily decomposed by light, heat, oxygen, or the like. When decomposition of the ionic organic colorant proceeds, fading occurs. In contrast, by adsorbing the ionic organic colorant in the layered silicate derivative, the decomposition of the ionic organic colorant can be suppressed. Therefore, by using the colored layered silicate-coated body as an alternative to such ionic organic colorants, the durability of color strength can be enhanced.

By selecting the type of ionic organic colorant, the colored layered silicate-coated body of the present disclosure can be provided with a color that silica alone cannot usually have.

A fourth embodiment of the present disclosure describes a method for manufacturing the layered silicate-coated body according to the third embodiment. The method described below is one aspect, and the method for manufacturing the layered silicate-coated body of the present disclosure is not limited to the following manufacturing method.

The layered silicate-coated body according to the first embodiment and a carried component are mixed in a solvent. Mixing can be performed at room temperature (e.g., from 5° C. to 40° C.). The mixing time may be, for example, from several minutes to several hours. For the solvent, it is possible to use a solvent capable of dissolving an electrolyte that electrolytically dissociates the carried component, and capable of dispersing the layered silicate-coated body of the present disclosure. For example, it is possible to use a mixed solvent including: a first solvent capable of dissolving an electrolyte that electrolytically dissociates the carried component; and a second solvent having mutual solubility with the first solvent and being capable of dispersing the layered silicate-coated body of the present disclosure. An example of the first solvent may include water. Examples of the second solvent may include low-polarity solvents, such as lower alcohols, having mutual solubility with water. An example of the mixed solvent may include a mixed solvent of water and ethanol (e.g., having a volume ratio of 1:1).

As regards the order of addition, either the layered silicate-coated body or the carried component may be added first, or they may be added simultaneously. The carried component may be dissolved in water separately, and the aqueous solution may be added to a dispersion medium of the layered silicate-coated body. It is thought that the carried component is ionized in the aqueous solvent. For the carried component, any of the aforementioned substances may be used. One type of carried component may be used, or a plurality of types may be used.

In cases where the carried component is an anionic substance, a salt or a compound (multivalent cation source) which can produce multivalent cations by electrolytic dissociation is dissolved in the aqueous solvent. Examples of the multivalent cation source may include, although not limited to, chlorides and hydroxides of multivalent cations. Examples of the multivalent cation source may include, although not limited to, calcium chloride (CaCl₂), magnesium chloride (MgCl₂), barium chloride (BaCl₂), and aluminum chloride hydrate ([Al(H₂O)₆]Cl₃). One or more types of the multivalent cation source may be used.

To increase the carrying rate, it is preferred to stir the aqueous solvent containing the carried component and the layered silicate-coated body.

The amount of addition of the carried component can be set as appropriate depending on the intended use. The proportion of addition of the carried component can be determined depending on the content by percentage of the carried component.

The amount of addition of the multivalent cation source can be set as appropriate depending on the amount of addition of the anionic substance.

Next, the layered silicate-coated body carrying the carried component is separated from the aqueous solvent by filtration or the like. Next, the separated layered silicate-coated body is dried. A layered silicate-coated body can be obtained thereby. In cases where the layered silicate-coated body does not need to be isolated, the separating step and the drying step do not have to be performed. Other steps, such as a washing step, may be included as appropriate.

Typically, silica particles alone cannot be made to carry a carried component simply by mixing the silica and the carried component. However, according to the manufacturing method of the fourth embodiment, even silica, which has difficulty in carrying a carried component directly, can be made to indirectly carry a carried component by a simple method.

According to the manufacturing method of the fourth embodiment, the layered silicate can carry a carried component regardless of whether the carried component is anionic or cationic. The layered silicate-coated body can be provided with desired functions by selection and combination of the carried components.

There may be cases where it is difficult, or utterly impractical, to directly define the layered silicate-coated body of the present disclosure based on the composition, structure, and/or properties thereof. In such circumstances, it should be permissible to define the layered silicate-coated body of the present disclosure according to methods for manufacturing the same.

### EXAMPLES

Layered silicate-coated bodies and methods for manufacturing the same of the present disclosure will be described hereinafter by way of examples. The layered silicate-coated bodies and the methods for manufacturing the same are not, however, limited to the following examples.

### Test Example 1

A solution including 0.072 g of sodium hydroxide and 0.035 g of sodium chloride dissolved in 5 ml of water, a solution including 0.32 g of aluminum acetylacetonate dissolved in 5 ml of ethanol, and a solution including 0.26 g of magnesium nitrate hexahydrate dissolved in 5 ml of ethanol were added simultaneously to a solution including 0.55 g of triethoxy-n-octylsilane dissolved in 15 ml of ethanol and having 0.5 g of monodisperse spherical silica particles with an average particle size of 2.5 μm dispersed therein, and the mixture was stirred at room temperature for 24 hours. Then, the product was washed, dehydrated, and dried, to obtain a sample of Test Example 1.

### Test Example 2

First, a solution including 0.28 g of triethoxy-n-octylsilane dissolved in 15 ml of ethanol and having 0.5 g of monodisperse spherical silica particles with an average particle size of 2.5 μm dispersed therein was stirred. Then, to this solution, a solution including 0.043 g of sodium hydroxide and 0.021 g of sodium chloride dissolved in 3 ml of water was added, and the mixture was stirred for 5 minutes. Then, a solution including 0.32 g of aluminum acetylacetonate dissolved in 5 ml of ethanol and a solution including 0.26 g of magnesium nitrate hexahydrate dissolved in 5 ml of ethanol were added, and further, a solution including 0.28 g of triethoxy-n-octylsilane, 0.029 g of sodium hydroxide and 0.014 g of sodium chloride dissolved in 2 ml of water was added, and the mixture was stirred at room temperature for 24 hours. Then, the product was washed, dehydrated, and dried, to obtain a sample of Test Example 2.

### Test Example 3

First, a solution including 0.28 g of triethoxy-n-octylsilane dissolved in 15 ml of ethanol and having 0.5 g of monodisperse spherical silica particles with an average particle size of 2.5 μm dispersed therein was stirred. Then, to this solution, a solution including 0.014 g of sodium hydroxide and 0.007 g of sodium chloride dissolved in 1 ml of water was added, and the mixture was stirred for 20 minutes. Then, a solution including 0.014 g of sodium hydroxide and 0.007 g of sodium chloride dissolved in 1 ml of water was further added, and the mixture was further stirred for 20 minutes. Then, a solution including 0.32 g of aluminum acetylacetonate dissolved in 5 ml of ethanol and a solution including 0.26 g of magnesium nitrate hexahydrate dissolved in 5 ml of ethanol were added, and further, a solution including 0.28 g of triethoxy-n-octylsilane, 0.043 g of sodium hydroxide and 0.021 g of sodium chloride dissolved in 3 ml of water was added, and the mixture was stirred at room temperature for 24 hours. Then, the product was washed, dehydrated, and dried, to obtain a sample of Test Example 3.

Scanning Electron Microscope (SEM) Observation and Transmission Electron Microscope (TEM) Observation:

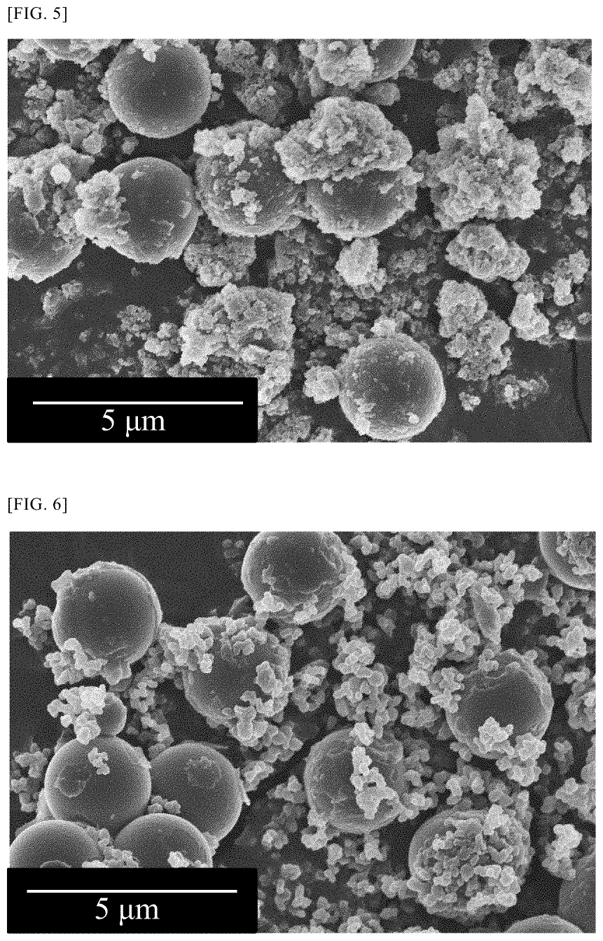

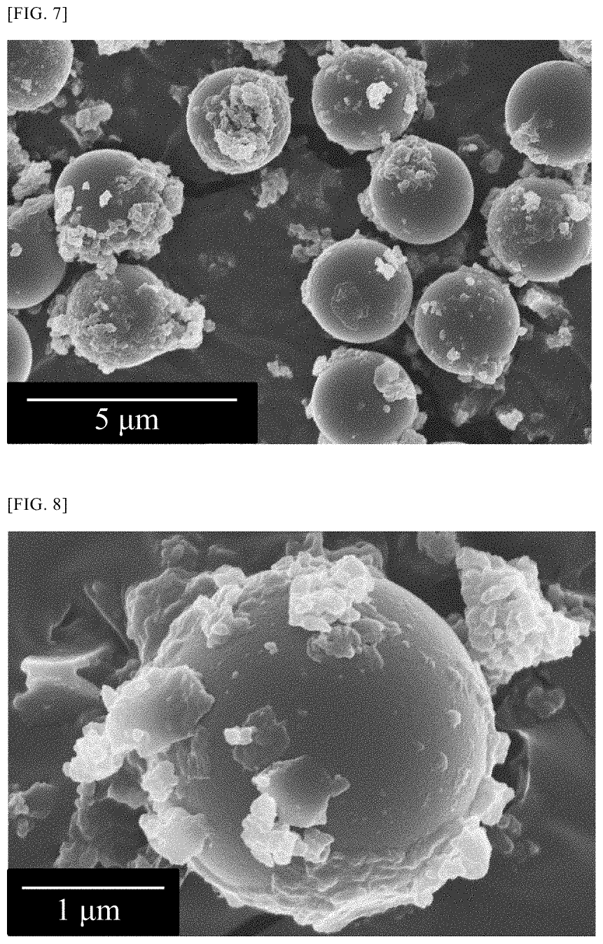

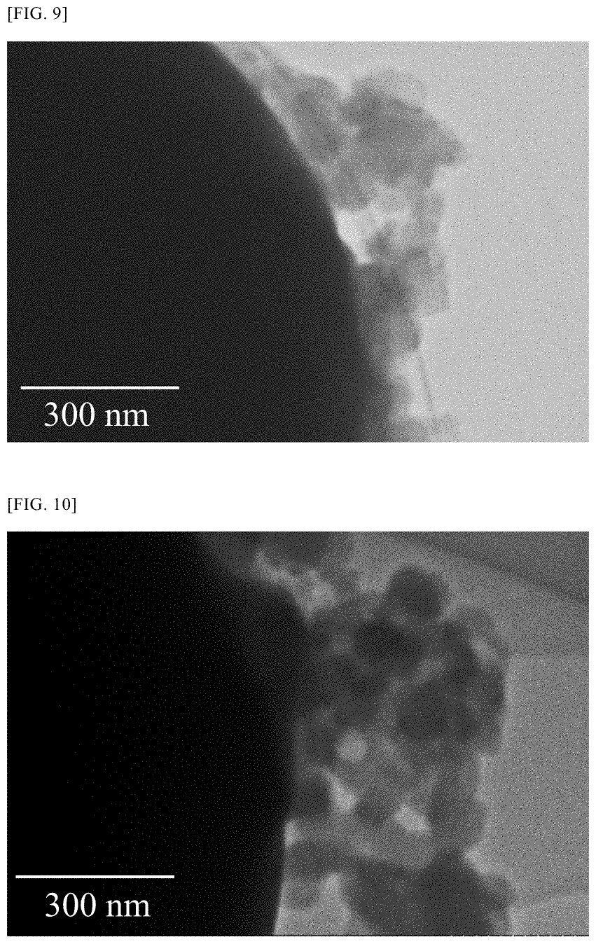

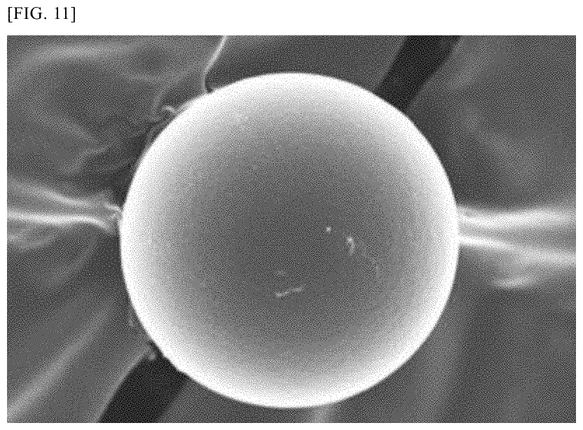

With respect to the products in Test Examples 1 to 3, the appearance and the surfaces of the particles were observed using a field emission scanning electron microscope (Hitachi SU-8000). Also, the particle surface of the product in Test Example 3 was observed using a transmission electron microscope. FIG. 5 shows an SEM image of the product in Test Example 1. FIG. 6 shows an SEM image of the product in Test Example 2. FIGS. 7 and 8 show SEM images of the product in Test Example 3. FIGS. 9 and 10 show TEM images of the product in Test Example 3. FIG. 11 shows an SEM image of a silica particle used as a material.

X-Ray Diffraction Measurement:

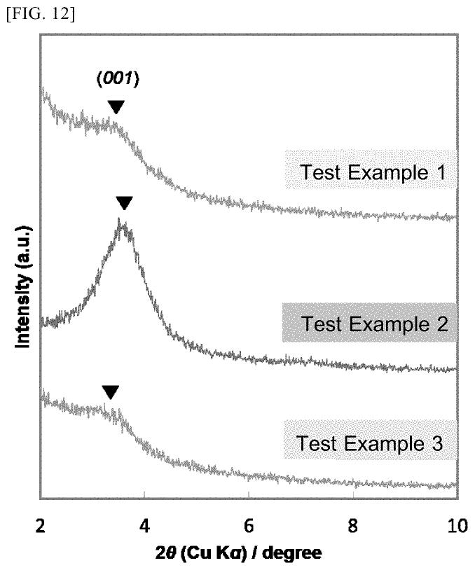

The products of Test Examples 1 to 3 were subjected to X-ray diffraction measurement (CuKα ray; Rigaku RINT 2200V/PC; 2θ=2-10°). FIG. 12 shows X-ray diffraction patterns of respective reaction products obtained in Test Examples 1 to 3. FIG. 12 shows charts for Test Example 1, Test Example 2 and Test Example 3 in the order from above.

Solid-State MAS NMR Measurement:

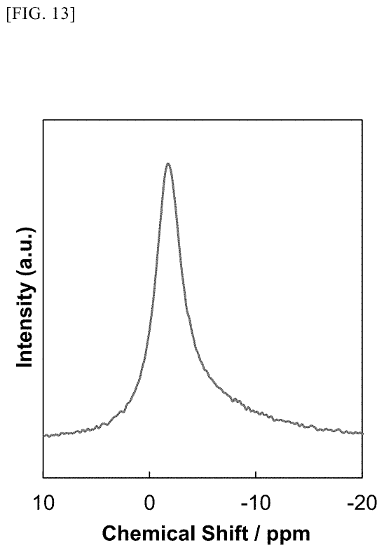

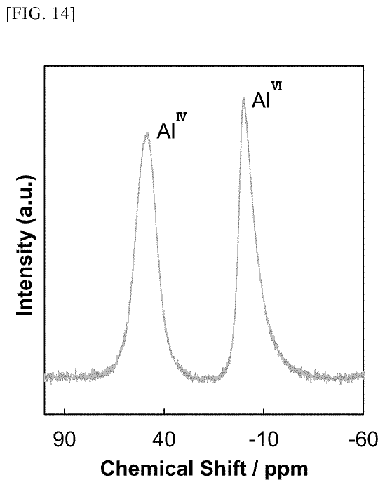

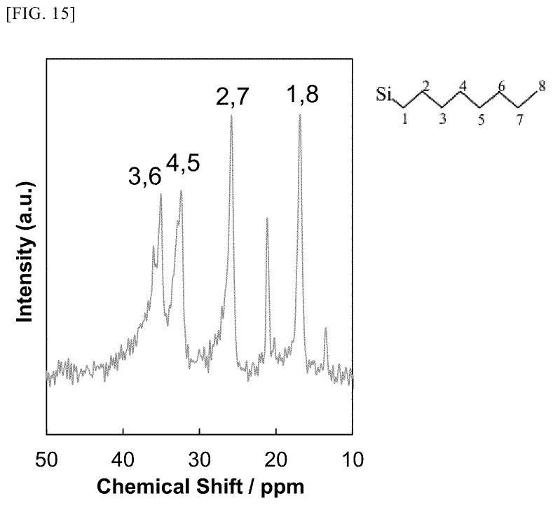

A sample according to the Test Example was subjected to solid-state MAS NMR measurement (ASCEND 500 from Bruker). FIG. 13 shows a solid-state ²³Na MAS NMR chart. FIG. 14 shows a solid-state ²⁷Al MAS NMR chart. FIG. 15 shows a solid-state ¹³C MAS NMR chart.

TG-DTA Measurement:

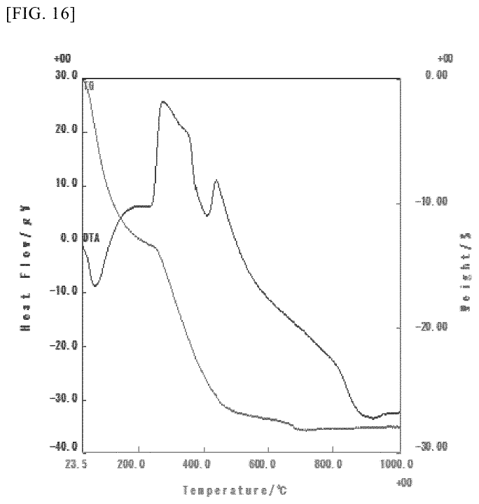

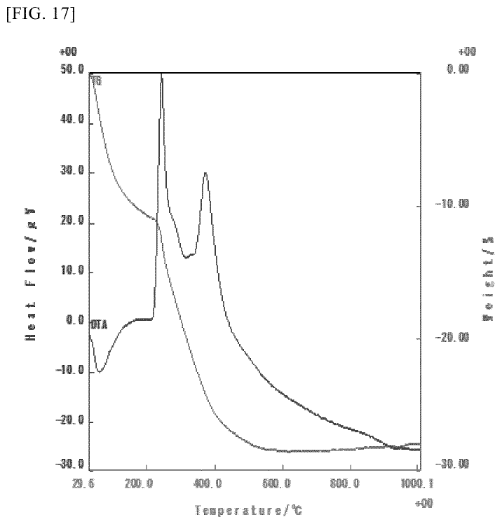

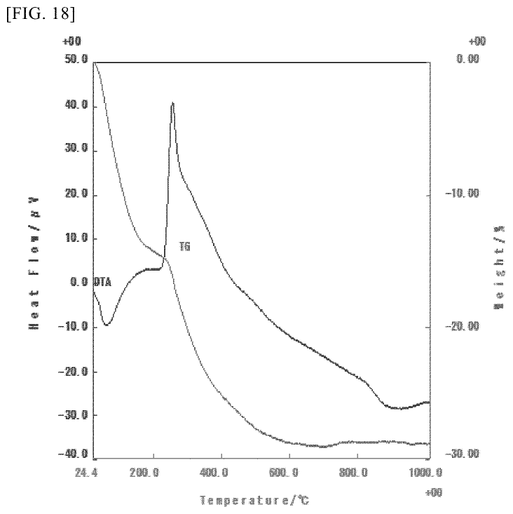

The products of Test Examples 1 to 3 and silica powder serving as a material were subjected to TG-DTA measurement (TG8120 from Rigaku Corporation; standard sample: alumina). The measurement temperature was from room temperature to 1000° C., and the temperature rise rate was 10° C./minute. FIG. 16 shows a chart for the product of Test Example 1. FIG. 17 shows a chart for the product of Test Example 2. FIG. 18 shows a chart for the product of Test Example 3.

FIG. 11 shows that the silica particle has a spherical shape. In contrast, FIGS. 5 to 10, which are images of the products, show that an adherent is present on the surface of the silica particles. The X-ray diffraction patterns of FIG. 12 showed a peak ascribable to the (001) plane of layered silicate (smectite). Further, according to solid-state NMR, the chart of FIG. 13 shows the presence of exchangeable sodium ions. The chart of FIG. 14 shows the presence of tetrahedrally coordinated and hexahedrally coordinated aluminum. That is, it was possible to confirm aluminum present in the tetrahedral sheets of the layered silicate and aluminum present in the octahedral sheets. Taken together, these results suggest that the adherent on the surface of the silica particles is a saponite-like layered silicate derivative.

The solid-state NMR chart of FIG. 15 shows peaks corresponding to eight carbon atoms. That is, it was possible to confirm an octyl group. This result shows that an octyl group has been introduced to at least either the silica particles or the layered silicate derivative.

The TG-DTA charts of FIG. 16 and FIG. 18 show an 18% mass reduction from the mass before analysis in the range from 120° C. to 800° C. TG-DTA of silica powder showed a 13% mass reduction from the mass before analysis. Therefore, of the mass reduction of the layered silicate-coated body, mass reduction amounting to 13% was ascribable to silica, and thus, mass reduction ascribable to combustion of the octyl group amounted to 5%. This result shows that there was 0.44 mmol of octyl groups per 1 g of the layered silicate-coated body.

The TG-DTA chart of FIG. 17 shows a 20% mass reduction from the mass before analysis in the range from 120° C. to 800° C. Mass reduction amounting to 13% was ascribable to silica, and thus, mass reduction ascribable to combustion of the octyl group amounted to 7%. This result shows that there was 0.62 mmol of octyl groups per 1 g of the layered silicate-coated body.

In Test Example 1, the materials were added all together. In Test Examples 2 and 3, silica and alkoxysilane were reacted before forming the layered silicate. Particularly, in Test Example 3, silica and alkoxysilane were reacted in stages. In FIG. 5 showing the product of Test Example 1, large amounts of layered silicate not adhering to the silica particles were observed. In contrast, in FIGS. 6 and 7 showing the products of Test Examples 2 and 3, the amount of layered silicate not adhering to silica decreased. Particularly, Test Example 3 had the smallest amount of layered silicate not adhering to silica. Also, in the product of Test Example 3, the layered silicate derivative seems to cover the silica particles more uniformly. These results suggest that it is preferred to react silica and alkoxysilane before causing the layered silicate to bond to silica. The results also suggests that it is preferred to react silica and alkoxysilane in stages by, for example, successive addition of a base.

### Test Example 4

### Coloring Test and Calculation of Content by Percentage of Saponite-Like Layered Silicate Derivative

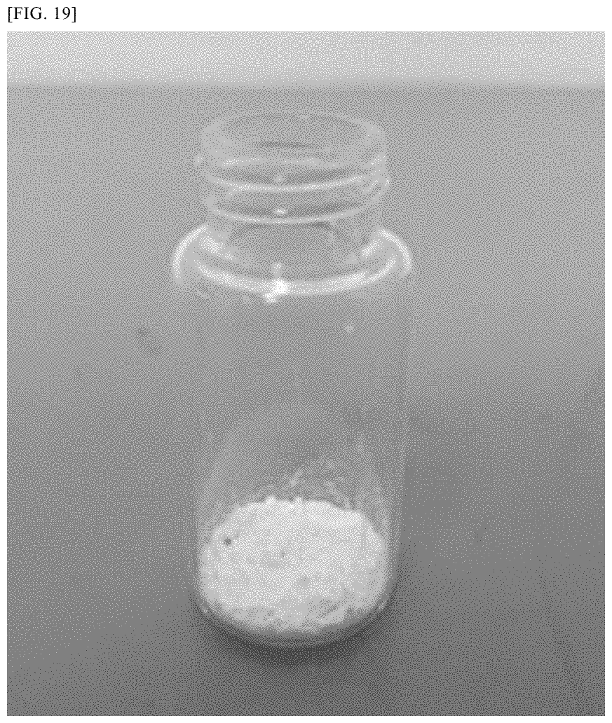

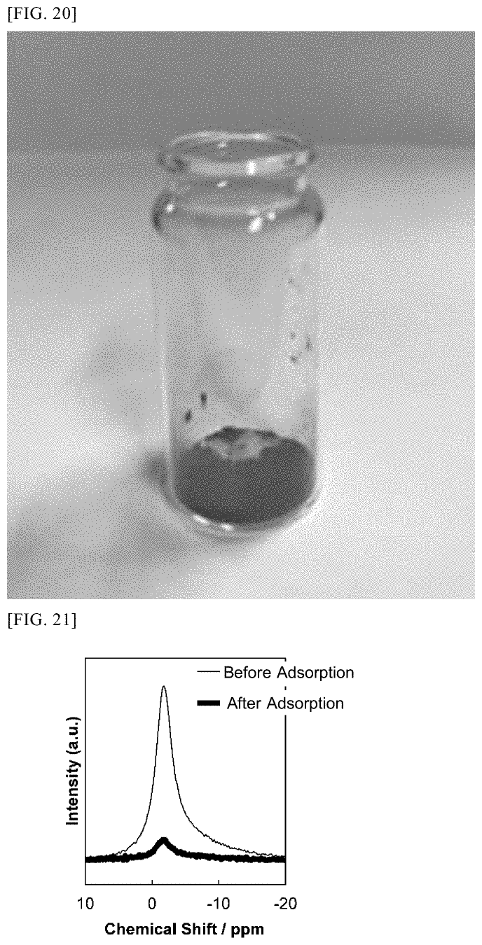

The saponite-like layered silicate-coated body obtained in Test Example 3 and methylene blue, which is an ionic organic colorant, were stirred for 24 hours in a mixed solvent containing 50 vol % of water and 50 vol % of ethanol. Then, the solid content was isolated and dried. FIG. 19 shows a photograph of the product of Test Example 3 before being colored. FIG. 20 shows a photograph of the product obtained in Test Example 4. The obtained product was subjected to solid-state ²³Na MAS NMR measurement. FIG. 21 shows a solid-state ²³Na MAS NMR chart.

FIG. 20 shows that the obtained powder was colored blue by methylene blue. Further, the solid-state NMR chart of FIG. 21 shows that the peak attributable to sodium ions after adsorption of methylene blue became lower than the sodium ion peak before adsorption. This shows that a layered silicate was formed, and also shows that interlayer sodium ions in the layered silicate derivative were cation-exchanged with methylene blue. Thus, it was confirmed that, according to the saponite-like layered silicate-coated body of the present disclosure, the layered silicate derivative can be made to support carried components, such as functional substances, through cation exchange.

The cation exchange capacity of the saponite-like layered silicate-coated body of Test Example 3 found from the methylene blue adsorption amount was approximately 0.156 mmol/g. The cation exchange capacity of pure saponite is approximately 0.71 mmol/g. This suggests that the saponite-like layered silicate-coated body of Test Example 3 contains 22% by mass of saponite-like layered silicate derivative.

### Test Example 5

### Water Repellency Test

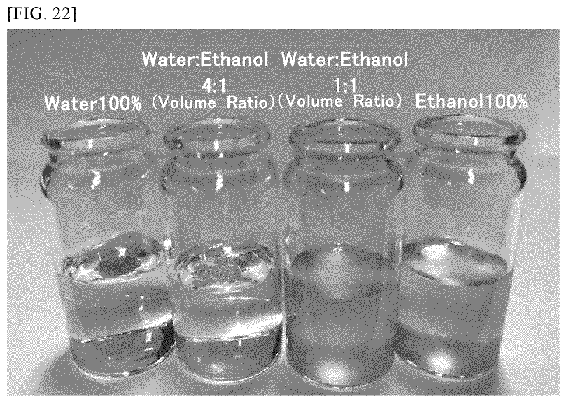

The layered silicate-coated body obtained in Test Example 4 was placed in each of a 100 vol % water solvent, a mixed solvent containing 75 vol % of water and 25 vol % of ethanol, a mixed solvent containing 50 vol % of water and 50 vol % of ethanol, and a 100 vol % ethanol solvent, to determine whether the layered silicate-coated body disperses or not. FIG. 22 is a photograph showing the dispersed states. In solvents with high water content, the layered silicate-coated body floated and could not be dispersed. In contrast, in solvents with high ethanol content, the entire liquid was colored blue, meaning that it was possible to disperse the layered silicate. This shows that the layered silicate-coated body of the present disclosure has high water repellency. Further, this shows that the layered silicate-coated body of the present disclosure can be dispersed in organic solvents such as alcohols.

The layered silicate-coated bodies and manufacturing methods therefor of the present disclosure have been described according to the foregoing embodiments and examples, but they are not limited to the foregoing embodiments and examples and may encompass various transformations, modifications, and improvements made to the various disclosed elements (including elements disclosed in the Claims, Description, and Drawings) within the scope of the invention and according to the fundamental technical idea of the invention. Further, various combinations, substitutions, and selections of the various disclosed elements are possible within the scope of the claims of the invention.

Further issues, objectives, and embodiments (including modifications) of the invention are revealed also from the entire disclosure of the invention including the Claims.

The numerical ranges disclosed herein are to be construed in such a manner that arbitrary numerical values and ranges falling within the disclosed ranges are treated as being concretely described herein, even where not specifically stated.

### INDUSTRIAL APPLICABILITY

The layered silicate-coated body of the present disclosure is applicable, for example, to cosmetics, paint, metal ion adsorbents, films, nanocomposite materials, and the like.

1. A layered silicate-coated body comprising:
a silica particle;
a saponite-like layered silicate derivative coating at least part of the silica particle; and
a hydrophobic functional group introduced to the silica particle and/or the layered silicate derivative.

2. The layered silicate-coated body according to claim 1, wherein the hydrophobic functional group is at least one selected from the group consisting of alkyl groups and aryl groups.

3. The layered silicate-coated body according to claim 1, wherein the hydrophobic functional group is an alkyl group having 6 or more carbon atoms.

4. The layered silicate-coated body according to claim 1, comprising from 0.01 to 10 mmol of the hydrophobic functional group with respect to 1 g of the layered silicate-coated body.

5. The layered silicate-coated body according to claim 1, wherein the layered silicate derivative occupies from 0.1 to 35% by mass of the mass of the layered silicate-coated body.

6. The layered silicate-coated body according to claim 1, wherein an average particle size of the silica particle is from 0.1 to 100 μm.

7. The layered silicate-coated body according to claim 1, further comprising a carried component carried by the layered silicate derivative.

8. The layered silicate-coated body according to claim 7, wherein the carried component is at least one selected from the group consisting of ionic functional substances and ionic organic colorants.

9. The layered silicate-coated body according to claim 8, wherein the functional substance contains at least one selected from the group consisting of antibacterial substances, bactericidal substances, sterilizing substances, and disinfecting substances.

10. The layered silicate-coated body according to claim 8, wherein the functional substance is at least one selected from the group consisting of metal ions, ionic metal complexes, and cationic surfactants.

11. The layered silicate-coated body according to claim 8, wherein the functional substance contains at least one selected from the group consisting of a silver ion, a zinc ion, a copper ion, a diammine silver ion, a benzalkonium ion, a benzethonium ion, a tetraethylammonium ion, and a didecyldimethylammonium ion.

12. The layered silicate-coated body according to claim 8, wherein the ionic organic colorant contains at least one selected from the group consisting of amaranth, new coccine, phloxine B, rose bengal, acid red, tartrazine, sunset yellow, fast green, brilliant blue, indigo carmine, lithol rubine B, lithol rubine BCA, methylene blue, rhodamine B, and erythrosine B.

13. The layered silicate-coated body according to claim 7, further comprising:
a multivalent cation;
wherein the carried component is anionic and/or amphoteric.

14. The layered silicate-coated body according to claim 13, wherein the multivalent cation is at least one selected from the group consisting of a magnesium ion, a calcium ion, an aluminum ion, and a barium ion.

15. A method for manufacturing a layered silicate-coated body in which at least part of a silica particle is coated with a saponite-like layered silicate derivative, and a hydrophobic functional group is introduced to the silica particle and/or the saponite-like layered silicate derivative, the method comprising:
a mixing step of mixing, in a solvent, the silica particle, alkoxysilane, a silicate component constituting the saponite-like layered silicate derivative, and a base at atmospheric pressure and at a room temperature.

16. The manufacturing method according to claim 15, wherein the mixing step comprises:
a first step of mixing the silica particle, the alkoxysilane, and the base; and
a second step of adding the silicate component to a mixture obtained in the first step.

17. The manufacturing method according to claim 16, wherein, in the first step, the base is added in stages.

18. The manufacturing method according to claim 16, wherein, in the second step, the alkoxysilane and the base are further added.

19. The layered silicate-coated body according to claim 13, wherein the carried component is at least one selected from the group consisting of ionic functional substances and ionic organic colorants.

20. The layered silicate-coated body according to claim 19, wherein the ionic organic colorant contains at least one selected from the group consisting of amaranth, new coccine, phloxine B, rose bengal, acid red, tartrazine, sunset yellow, fast green, brilliant blue, indigo carmine, lithol rubine B, lithol rubine BCA, methylene blue, rhodamine B, and erythrosine B.
